(19) United States
(12) Patent Application Publication
(10) Pub. No.: US 2002/0113224 A1
(43) Pub. Date: Aug. 22, 2002

(54) Crosslinking ionotropic gels

(76) Inventor: Ulrich Zimmermann, Waldbrunn (DE)

Correspondence Address: Kevin S. Lemack, Nields & Lemack, 176 E. Main Street, Westboro, MA, 01581, US

(21) Appl. No.: 09/976,221

(22) Filed: Oct. 12, 2001

Related U.S. Application Data
(62) Division of application No. 09/627,612, filed on Jul. 28, 2000, now abandoned.

(30) Foreign Application Priority Data
Jul. 28, 1999 (DE) 199 35 231.3

(51) Int. Cl. C09K 3/00

(52) U.S. Cl. 252/182.32

(57) ABSTRACT

A crosslinking agent for crosslinking ionotropic gels by linking gel molecules by counterion bridges contains the counterions in a state wherein they are bound to a carrier substance. The counterions can be released from the carrier substance under the external influence of a substance, temperature or radiation. For crosslinking of the gel, first a mixture of the gel molecules to be crosslinked and the crosslinking agent is prepared, a molded body is produced from this mixture and then crosslinking of the gel molecules is induced by the release of the counterions from the carrier substance through the external influence of a substance, temperature or radiation.

This invention relates to a crosslinking agent for crosslinking ionotropic gels, compositions of ionotropic gels and such crosslinking agents, a method of crosslinking ionotropic gels and applications of this crosslinking agent.

Ionotropic gels are highly elastic, reversibly swellable ion exchange gels consisting of macromolecules which are crosslinked by ion bridges. The ion bridges are formed by counterions to the gel molecules. It is known that ionotropic gels in an aqueous solution can be crosslinked easily by adding a suitable counterion solution to the gel solution. However, the disadvantage of such crosslinking in the solution volume is that the crosslinking or polymerization does not proceed evenly, because mass transport of counterions to other crosslinkable gel molecules is prevented in particular in those areas of volume where crosslinking has already taken place. Thus, as a result of the traditional crosslinking in solution, crosslinked gels with inhomogeneous crosslinking on a molecular level leading to end products with irregular gel surfaces are obtained. This inhomogeneity is the disadvantage that greatly restricts the use of crosslinked gels, especially in the fields of biology and medicine.

An example of an ionotropic gel would be the alginates obtained from algae. Alginates have numerous applications in food technology (see, for example, Askar in “Alimenta”, volume 21 (1982) pages 165 ff) and in medicine, biochemistry and biotechnology. For example, DE-OS 42 04 012 discloses the formation of alginate capsules crosslinked with Ba²⁺ ions for applications in implantation medicine. These alginate capsules are produced by dropwise addition of an alginate solution containing the biological cells to be encapsulated to a Ba²⁺ solution. Crosslinking of the gel begins immediately with dropwise addition to the ion solution, leading to closed alginate capsules. However, the problem of inhomogeneous crosslinking mentioned above also occurs with this method of forming capsules. Crosslinking begins from the outer surface, hindering the formation of ion bridges between gel molecules beneath the surface even after crosslinking. As a result, these alginate capsules have inhomogeneous surfaces on a molecular level.

Studies with a scanning force microscope (SFM) have shown that a possible immunological reactivity of the surface of alginate capsules can be attributed specifically to geometric inhomogeneities in particular. Inhomogeneities in crosslinking have a negative effect on the cellular processes responsible for the primary foreign body reactions (i.e., secretion of traces of material by fibroblasts, macrophages and/or lymphocytes during their migration over surfaces).

In addition to influencing the immunological reactivity of alginate transplants, inhomogeneity in crosslinking also has a negative effect on the long-term stability of the transplanted capsules. The alginate capsules are exposed to uptake of water or withdrawal of water, depending on ambient conditions, in the transplanted state, so that these capsules undergo a deformation which is associated with forces acting on the capsule material. It can be assumed that the inhomogeneous crosslinking of alginates reduces the resistance of these capsules to such forces in a negative manner.

These problems also occur with other ionotropic gels which are used in dentistry, for example. Therefore, there is an interest in achieving homogeneous crosslinking of ionotropic gels even on a molecular level in order to overcome the previous restrictions on their applications in biology and medicine.

The object of this invention is to provide an improved crosslinking agent for ionotropic gels with which homogeneous gel crosslinking is achieved. The object of this invention is also to describe an improved crosslinking method for producing homogeneously crosslinked gels and novel applications of these gels. These objects are achieved by a crosslinking agent, a gel solution, a powder composition and a method having the features according to patent claims 1, 7, 8 and 9. Advantageous embodiments and applications of this invention are derived from the dependent claims.

The basic idea of this invention consists of creating a crosslinking agent for crosslinking ionotropic gels by joining gel molecules by counterion bridges, where the crosslinking agent contains the counterions in a condition where they are bound to a carrier substance, where the counterions can released from the carrier substance under the external influence of a substance, temperature or radiation. Such a crosslinking agent makes it possible to carry out a novel crosslinking method which provides, first of all, homogeneous mixing of the gel molecules to be crosslinked on the one hand and the counterions bound to the carrier substance on the other hand, and this can be converted to a desired form, depending on the application, whereupon the counterions in the crosslinking agent are released under the external influence of a substance, temperature or radiation, with the counterions forming bridges between the gel molecules. This thorough mixing of the starting components may take place either in the dissolved state or in a dried and finely pulverized state. In contrast with traditional crosslinking, where the formation of counterion bridges is initiated immediately upon combining the dissolved starting components, thereby entailing the above-mentioned disadvantages regarding the homogeneity in crosslinking, a uniform distribution of the crosslinking agent between the ionotropic molecules can be ensured according to this invention. Before crosslinking, the counterions in the starting components are still ineffective because they are bound to the carrier substance, and have a homogeneous distribution in space, so that counterion transport is not hindered in a negative manner when crosslinking begins after the start of the external treatment with a substance, temperature or radiation.

In preferred embodiments of the crosslinking agent according to this invention, the carrier substance is formed by so-called cage substances which bind the counterions (multivalent cations or anions) in an electronic ground state and release the counterions in an electronic excitation state. Depending on the application, cage substances are preferred for use with divalent cations, such as Ca²⁺ or Ba²⁺ cage compounds. Transitions from one state to another can be induced to advantage by simple radiation with light of a suitable wavelength.

According to a modified embodiment of this invention, the counterions and the carrier substance are present as a salt compound in the crosslinking agent, and the salt compound is then dissolved with a change in pH in the ambient solution.

This invention yields the following advantages. The crosslinking according to this invention permits a gel crosslinking process which begins simultaneously throughout the entire starting volume and thus proceeds homogeneously. Thus, it is possible to create gel samples having a smooth surface that is homogeneous on a molecular level; these gels have an improved biocompatibility and stability when used as transplant materials or as dental filling materials. However, this invention also creates some completely new applications for ionotropic gels, because handling of the gels is greatly simplified by this new crosslinking agent.

Additional details and advantages of this invention are apparent from the description of the accompanying drawings, which show:

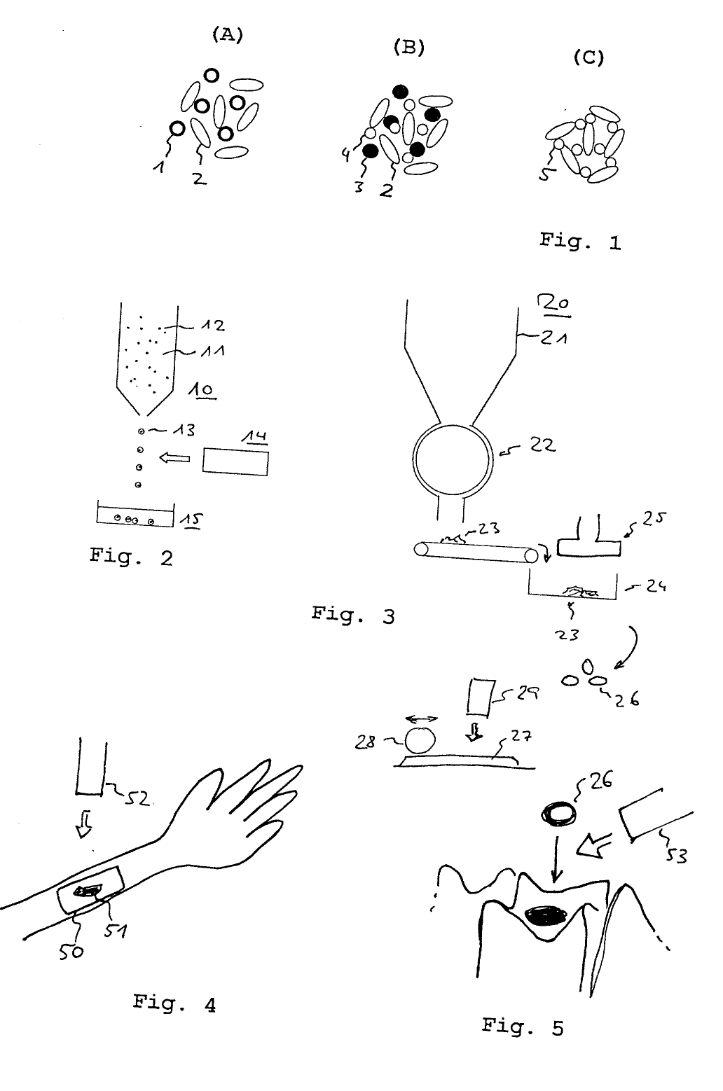

FIG. 1 a schematic illustration of the effect of a crosslinking agent according to this invention,

FIG. 2 a schematic diagram of a first arrangement for the implementation of the method according to this invention,

FIG. 3 a schematic diagram of an additional arrangement for the implementation of the method according to this invention,

FIG. 4 an illustration of application of this invention in forming wound dressings, and

FIG. 5 an illustration of application of this invention in dentistry.

This invention is explained in greater detail below with reference to crosslinking of alginates with divalent cations. The reference to alginates is given here only as an example. This invention can also be used accordingly with other ionotropic gels such as DEAE-polyhydroxy compounds, in particular for cosmetic applications and polysaccharides which are known by the name Sephadex (registered trademark). Additional example include ionotropic cellulose derivatives and anion or cation exchangers such as DEAA-cellulose, DEAE-cellulose, ECTEOLA-cellulose, TEAE-cellulose, DEAE-Sephadex, n-octylamino-Sephadex, polyaminopolystyrene, Amberlite IR 45, Amberlite IRA 93, Amberlite IRA 410, or Amberlite IRA 900 or CM cellulose, cellulose citrate, p cellulose, Amberlite CG 50, Amberlite IRC 50, Amberlite IR 120, Amberlite IR 200, Amberlite XE 97, or Dowex 50. The principles of this invention as explained below can also be applied accordingly.

The crosslinking agent according to this invention consists of a carrier substance-counterion compound. This compound may be of a physical or chemical nature. When using cage substance as the carrier substance, a counterion is held by a cage molecule as in a cage-like enclosure. Examples of cage substances include DM-Nitrophen (registered trademark of Calbiochem Novabiochem) which is suitable for forming cages for Ca²⁺ or Mg²⁺ ions, or the chelate molecules which are also suitable as cage substances for Ca²⁺ ions and are described by J. H. Kaplan et al. in “Proc. Nat, Acad, Soc. USA”, volume 85 (1988), pages 6571 ff. The cage substance are characterized in that they have the cage-like molecular shape in the ground state and they undergo a change in conformation with electronic excitation, causing the captured ion to be released. This electronic excitation takes place, for example, through exposure to UV light.

FIG. 1 illustrates the steps in gel crosslinking with a crosslinking agent according to this invention. The left FIG. (A) shows a homogeneous mixture of the crosslinking agent 1 and gel molecules 2. The particles illustrated in the diagram need not necessarily be individual molecules but may optionally also be larger molecular structures, even as large as powder particles. The composition in state (A) is either dry (powder) or dissolved (solution state, ambient solvent not shown).

With UV light exposure, the system is converted to state (B), (middle figure) where the crosslinking agent is dissolved in the carrier substance 3 and counterions 4. Counterions 4 are therefore homogeneously distributed throughout the entire volume in which the gel molecules that are to be crosslinked are also distributed. Immediately after their release, crosslinking begins (formation of counterion bridges 5) , leading to state (C). The crosslinked gel is characterized by formation of a bridge with a homogeneous distribution. Optionally a step for extraction of the remaining carrier substance may also be provided.

As an alternative to the formation of the carrier substance by cage substances, the crosslinking agent may also contain ions that form a salt with the counterions for gel crosslinking as the carrier substance. For example, calcium carbonate or barium carbonate is an example of a crosslinking agent that is of interest for alginate crosslinking by forming calcium bridges. In this case, release of the counterions is not achieved by exposure to light, but instead by means of a substantive change or physical change in the ambient solvent. By acidification of the solution or suspension of alginates and calcium carbonate, the calcium ions are released and thus made available for crosslinking of the alginate.

With additional crosslinking agents, the carrier substance may release the counterions when heated.

FIG. 2 illustrates a first application of the crosslinking method according to this invention. To form alginate capsules with a nozzle arrangement, a suspension of an alginate solution 11, to which the crosslinking agent is added in dissolved form, and biological cells 12 which are to be encapsulated is prepared in a droplet generator 10. Suspension droplets 13, usually containing a cell to be enclosed, are released by a mechanism which is selected according to the application. Immediately after these droplets are released, they are exposed to light with a lighting device 14 (such as a flash lamp, a UV laser or the like). This corresponds to the transition from state (A) to state (B) according to FIG. 1. The counterions in the crosslinking agent are released and crosslinking begins. The crosslinked capsules are collected in a collecting device 15 and then sent for further use, such as transplantation into a living organism. The alginate solution 11 of gel molecules and crosslinking agent prepared in the droplet generator 10 is an important aspect of this invention because it can be produced to advantage even before the addition of the living cells, is stable over a long period of time and can be used according to the application.

An alternative, solvent-free method is illustrated in the diagram in FIG. 3. A storage container 21 is provided in a mill 20, where the dried starting materials consist of the uncrosslinked gel material and the crosslinking agent premixed in the container. The starting components are milled in a mill 22, resulting in a homogeneous mixture according to state (A) in FIG. 1. This mixture 23 is collected in a collecting device 24 and either tableted or pelletized in a pressing device 25 to form tablets or pellets 26. These tablets 26 are then sent for further use (see below) Immediately before the desired crosslinking, the pressed powder is partially dissolved or swollen and exposed to light or heated or a substance is added in order to release the counterions from the substance in the crosslinking agent. As an alternative, the mixture 23 may also be applied to a suitable substrate as layer 27 using a coating device 28. After a suitable pre-swelling or partial dissolving, the swollen or partially dissolved layer 27 is exposed to suitable light with a lighting device to induce crosslinking of the gel. Then, the gel layer can be released from the substrate, optionally comminuted and sent for further use.

Preferred applications of crosslinking gels according to this invention are described below.

Preparation of Wound Dressings

FIG. 4 illustrates a novel and especially advantageous application of ionotropic gels for producing temporary wound dressings for work-related injuries or sports injuries, for example. A gel solution comprising an aqueous solution of the gel molecules to be crosslinked and the crosslinking agent is applied as a cover layer 50 to the injury 51. During or immediately after application of layer 50, the counterions are released from the crosslinking agent by exposure to a lighting device 52, so that crosslinking of the gel is initiated and the closed gel layer is formed after a short period of time.

In this application, the biocompatibility of ionotropic gels is especially advantageous, because only substances that are good for the skin and cause little or no defensive action are allowed to come in contact with the exposed tissue when applied directly as a wound dressing.

A wound dressing produced by the method described here is especially suitable for protecting against burns, because these alginates with their stable crosslinking provide reliable protection against drying for the tissue covered by this dressing.

Producing Temporary Dental Fillings

Another application of this invention, in particular the pressed powder composition 26 prepared according to FIG. 3, is for the production of dental fillings. A tablet 26 is inserted as a temporary filling into a cavity in a tooth, where it is partially dissolved or swollen and exposed to light using a lighting device 53. The release of counterions is induced directly by this light exposure throughout the entire body of the tablet 26.

Similar applications are derived with the creation of temporary implants in bone materials.

Applications in Food Technology

Alginates crosslinked according to this invention can be used to particular advantage in a known way as a component of foods in order to change their strength or taste properties.

Because of the great stability of the homogeneous gel crosslinking achieved according to this invention, these alginates are especially suitable for encapsulating active ingredients in foods in such a way as to yield an encapsulation that is neutral as to taste. For example, fish oil can be encapsulated into crosslinked alginates according to this invention and then baked in bread. Because of the great stability of the homogeneous crosslinking, these alginate capsules remain stable even when baked and eaten, so that a neutral taste remains unaffected by the active ingredient.

Other food technology applications include encapsulation of microorganisms for bioreactor production of L-amino acids, degradation of starch to glucose and fructose, production of antibiotics, acetic acid, beverages such as beer and wine, milk products such as cheese and yogurt, production of alkaloids, enzymes, fatty acids and other organic compounds, encapsulation of plant cells and organelles for production of secondary plant products such as alkaloids (e.g. allicin, lycopin), encapsulation of fluorouracil, methoxtrexate and other cytotoxic compounds that are released in the intestine after degradation of the capsules for local specific treatment of colon cancer, encapsulation of ω-fatty acids, cod liver oil, algai extracts and other compounds that are important for human nutrition but are not tasty, encapsulation of proteins, enzymes, vitamins and minerals for long-term (or delayed) release in the intestine, and encapsulation of vaccines.

Additional similar applications are derived from encapsulation of active ingredients in cosmetics. For example, applications include the encapsulation of vitamins, enzymes, liposomes, oils, plant extracts, essential oils, drugs, antibiotics, anti-viral compounds and fungicides, face mask material, (sticking) plaster or bandage material and ointments containing e.g. drugs, plant extracts, cooling agents or essential oils against physical problems such as pain, contusions, bruises, rheumatic and arthritic pain, phlebitis and other physical disorders treatable via the skin.

Applications in Transplantation Technology

Suitable applications in transplantation technology include replacement of endocrinic disorders by transplantation of appropriate healthy (allogeneic or xenogeneic) endocrinic cells or tissue; parthyroid tissue, islets, embryos, etc. (for the treatment of the following diseases: hypoparathyroidism, Alzheimer, Parkinson, epilepsy, Huntington's, dwarfism, strokes, hemophilia, chronic pain, spinal cord injuries, kidney failure, diabetes, cancer, AIDS, wound healing, muscular dystrophy, atherosclerosis, infertility, syringomyelia, liver failure, enzymatic defects, anemia, disorder of the central nervous system). (allogeneic means human tissue into patients; zenogenic means animal (in particular procine) tissue into patients.)

Other suitable transplantation applications include transplantation of autologous cells and tissues, i.e., of cells which were taken from the patient, expanded in culture and then reinjected into the patient after immobilization in cross-linked ionotropic gels (e.g. chondrocytes for healing of cartilage defects; osteoblasts for healing of bone defects; fibroblasts and keretinocytes for wound healing/skin repair); transplantation of permanent cell lines that secrete therapeutic molecules such as hormones, factors, or enzymes which cannot be produced by the body itself or in sufficient amounts (e.g., dopamine-secreting cell lines for therapy of Parkinson's disease); transplantation of cell lines for gene therapy (e.g., encapsulated, genetically modified fibroblasts, myoblasts, stem cells, chromaffin cells or other animal cells or microorganisms that deliver recombinant gene products such as human growth hormone, factor VIII, factor IX, lysosomal enzymes, basic fibroblast growth factor (b-FGF), transforming growth factor β (TGF-β), tumor necroses factor α (TNF-α), interleukine, cytokine, chemokine, pain-reducing substances, neurotropic factors; application of cross-linked ionotropic gels for incorporation of therapeutic molecules listed above, e.g. controlled release thereof after implantation; transplantation of tumor vaccines and of monoclonal antibody-secreting hybridoma cells.

1. A crosslinking agent (1) for crosslinking ionotropic gels by linking gel molecules (2) by counterion bridges (5), characterized in that
the crosslinking agent contains the counterions (4) in a state where they are bound to a carrier substance (3), and the counterions (4) can be released from the carrier substance (3) under the external influence of a substance, temperature or radiation.

2. The crosslinking agent according to claim 1, where the carrier substance consists of cage molecules which bind the counterions in an electronic ground state and release the counterions in an electronic excitation state.

3. The crosslinking agent according to claim 2, where the cage molecules are formed from cage substances such as those used in cellular physiology for transport of divalent ions into biological cells.

4. The crosslinking agent according to claim 1, where the carrier substance and the counterion form a salt compound which can bedissolved under the influence of an acidifying solution.

5. The crosslinking agent according to claim 4, consisting of calcium carbonate.

6. The crosslinking agent according to one of the preceding claims, designed for the crosslinking of alginic acid molecules.

7. A gel solution containing an ionotropic gel and a crosslinking agent according to one of claims 1 through 6.

8. A powder composition consisting of a dried, uncrosslinked ionotropic gel and a dried crosslinking agent according to one of claims 1 through 6.

9. A method of crosslinking ionotropic gels using a crosslinking agent according to one of claims 1 through 6 with the steps:
providing a mixture of the gel molecules to be crosslinked and the crosslinking agent,
forming a layered body or a volume-molded body of the mixture, and
crosslinking the gel molecules by the external influence of a substance, temperature or radiation, which causes the counterions to be released from the carrier substance.

10. The method according to claim 1, whereby the first step comprises providing an aqueous solution of the gel molecules to be crosslinked and adding the crosslinking agent.

11. The method according to claim 9, where the first step includes mixing and grinding a powder of the uncrosslinked gel molecules and the crosslinking agent.

12. The method according to one of claims 9 through 11, whereby the crosslinking is induced by UV light exposure.

13. The method according to one of claims 9 through 11, whereby the crosslinking is induced by acidification.

14. The method according to one of claims 9 through 13, whereby the crosslinked ionotropic gel is formed in capsule form.

15. The method according to claim 14, whereby live biological cells are encapsulated in the capsules.

16. A use of a crosslinking agent according to one of claims 1 through 6 or a gel solution according to claim 7 or a powder composition according to claim 8 for
preparing wound dressings,
preparing dental fillings,
producing transplant encapsulations,
producing active ingredient encapsulations for food technology, and
producing active ingredient encapsulations for cosmetics.
